(19) United States
(12) Patent Application Publication
(10) Pub. No.: US 2022/0225827 A1
(43) Pub. Date: Jul. 21, 2022

(54) COOKER INSULATOR

(71) Applicant: Steve Hill, Millcreek, UT (US)

(72) Inventor: Steve Hill, Millcreek, UT (US)

(21) Appl. No.: 17/150,054

(22) Filed: Jan. 15, 2021

(51) Int. Cl. A47J 37/07; A47J 36/36

(52) U.S. Cl. CPC A47J 37/0786; A47J 36/36

(57) ABSTRACT

The present invention is directed to apparatuses directed to regulating heat within and preventing heat loss from cookers such as electric, gas, woodburning, coal or charcoal grills and smokers. In particular, the disclosed apparatuses comprise an insulative, flame retardant, formable, non-rigid, self-supporting, single-layer insulating cover to shroud the exterior of an existing cooker. The cover comprises a uni-layer and substantially homogenous material.

### BACKGROUND OF THE INVENTION

### 1. Field of the Invention

The present invention relates to apparatuses for insulating cooking devices for heat control and retention. In particular, the present invention is directed to regulating heat within and preventing heat loss from cookers such as electric, gas, woodburning, coal or charcoal grills and smokers. Regulating heat within cooking/smoking devices controls and optimizes cooking/smoking process. It also reduces unnecessary fuel consumption. The insulating apparatuses of the present invention promote cooking/smoking while reducing fuel consumption.

### 2. Background and Related Art

Cooking techniques including smoking, barbecuing, and grilling have developed from early processes for preserving foods. That is, food processing techniques have been used to reduce the rate at which food spoiled thereby prolonging food shelf life. These techniques also determine the rate of cooking as well as the taste, tenderness, and texture of many different types of meat and other foods such as vegetables, nuts, fruit, cheeses, salts, or other products. Often smoking, barbecuing, and grilling rely on combustion of fuel to produce the desired heat, chemicals and pH levels which process the food and slow the growth of degrading microbes.

Barbecuing and grilling typically process food in a shorter, more rapid cooking period. Smoking typically requires a longer cooking period. Depending on the nature of the food and the desired outcome, smoking, barbecuing, or grilling can serve different purposes. For example, meat with large amounts of connective tissue and a fair amount of fat cook differently when smoked, barbecued, or grilled.

The type of fuel also impacts the cooking technique and process. Cooking devices may accommodate one or more types of fuel such as electricity, gas, coal, wood, processed pellets, charcoal, other available fuel, or a combination of fuel sources. Choice of fuel can determine ranges of temperature, rates of combustion, production of desired chemicals, pH levels and flavor. For example, different kinds of wood produce different results. The flavor of smoke from burning wood is also affected by the location, climate, and soil of the tree rather than by the type of tree itself. Generally air-dried, hardwoods are preferred for smoking foods including, but not limited to alder, apple, hickory, maple, mesquite, pecan, oak, cherry, grapevine cutting, etc. Softwoods are less desirable. When wood burns it produces nitrogen dioxide-laden smoke which contacts the food or product and dissolves losing its oxygen molecules. Once it loses its oxygen, it becomes acidic, and it tries to find something new to attach to in order to stabilize. In meat the acid finds myoglobin; myoglobin attracts the acid and pulls it into the meat and in doing so draws in the associated flavor or character of the wood smoke.

Temperature is important. For example, there are two types of smoking, namely, hot, and cold. Cold smoking occurs at relatively low temperature away from the combustion of the fuel such as in a different chamber and typically does not actually cook the food or product. Hot smoking techniques occur when the food or product is directly adjacent the combusting fuel or in the same chamber as the combusting fuel and cooks the food or product as it smokes. Hot-smoked items typically result in a firmer, drier texture. As a result temperature, timing and moisture control are essential. Preferred hot smoking temperature is around 212° F. giving the smoke time to penetrate and naturally tenderize the meat. Slow cooking gives the natural fibers in meat time to break down and become tender. Temperature control is critical.

Fat in foods such as meat is an important factor in smoking, barbecuing, and grilling. When fat is processed at high temperatures it can make meat tough because fat tissues contain collagen which tightens under high temperature. Slower smoking of meat can have the opposite effect on collagen, instead of tightening the collagen lower-temperature smoking melts them. For example, when wood combusts, cellulose in the wood breaks down into sugar, which caramelizes on the fat, therefore breaking down collagen. Moisture can then penetrate the fat creating softer and more savory fatty by-products.

Because smoking/barbecuing/grilling factors such as the rate of fuel combustion, temperature control, duration of the cooking period and introduction of flavor impact the cooking techniques and the resulting product, being able to control and/or regulate these factors is desirable. To this end, different mechanisms have been developed and used to control and/or regulate such factors. One mechanism has been the use of an overlaying shell or cover. For example, U.S. Pat. Nos. 5,582,094 and 9,468,337 disclose various insulating shells and covers.

Accordingly, it would be an improvement in the art to provide insulating apparatuses whose construction is simplified, can be handled without personal protective equipment and which provide superior insulating properties thereby providing the user the ability to selectively control and regulate smoking, barbecuing and grilling factors as desired.

### SUMMARY OF THE INVENTION

The present invention relates to apparatuses directed to regulating heat within and preventing heat loss from cookers such as electric, gas, woodburning, coal or charcoal grills and smokers. In particular, the disclosed apparatuses comprise a formable, non-rigid, self-supporting, single-layer insulating cover to shroud the exterior of an existing cooker. The cover comprises a uni-layer and substantially homogenous composition. The cover may be a single, unitized member and provide its own principal structural framework of support without any adjacent rigid shell or skin.

The insulating cover apparatuses of the present invention are used to increase the thermal resistance and regulation properties of standard cookers. The cookers can be of any configuration such round, rectangular, cylindrical, flat- or dome-topped, square, or other physical shapes or combination of shapes.

The insulating covers are constructed of an insulating material for heat retention and regulation. Desirable materials are generally flame retardant. The insulating material may be hygroscopic such that it absorbs and retains moisture while maintaining its insulating abilities thereby eliminating the need for a secondary outer layer for water shed/protection. In addition, the material may be formable, non-rigid, self-supporting, single-layered, flame retardant and/or have the ability to absorbs and retains moisture if such conditions are present. An example of such a construction material is wool or a wool blend.

Furthermore, the features and advantages of the invention may be learned by the practice of the invention or will be obvious from the description, as set forth hereinafter.

### BRIEF DESCRIPTION OF THE DRAWINGS

In order that the manner in which the above recited and other features and advantages of the present invention are obtained, a more particular description of the invention will be rendered by reference to specific embodiments thereof, which are illustrated in the appended drawings. Understanding that the drawings depict only typical embodiments of the present invention and are not, therefore, to be considered as limiting the scope of the invention, the present invention will be described and explained with additional specificity and detail through the use of the accompanying drawings in which:

FIG. 1 illustrates a perspective view of one embodiment of the insulating cover of the invention draped over a cooker, with cross-section line A-A.

FIG. 2 further illustrates the embodiment of FIG. 1 in cross-sectional view along line A-A.

FIG. 3 illustrates an enlarged portion of FIG. 2 at B.

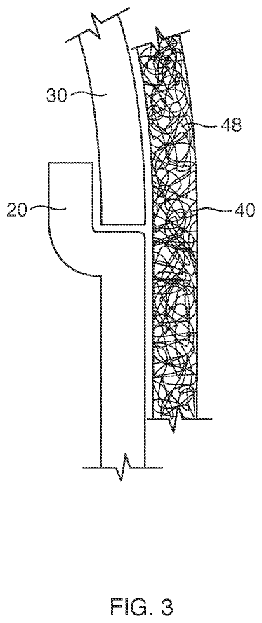

FIG. 4 illustrates a top view of one embodiment of the insulating cover of the invention.

FIG. 5 illustrates a top view of another embodiment of the insulating cover of the invention.

FIG. 6 illustrates an exemplary embodiment of joining separate members to form the insulating cover of the invention.

### DETAILED DESCRIPTION OF THE INVENTION

The present invention relates to apparatuses and features of insulating cooker covers constructed of an insulating material which is formable, alterable, non-rigid, self-supporting, single-layered, flame retardant and/or absorbs and retains moisture thereby providing superior heat retention and regulation.

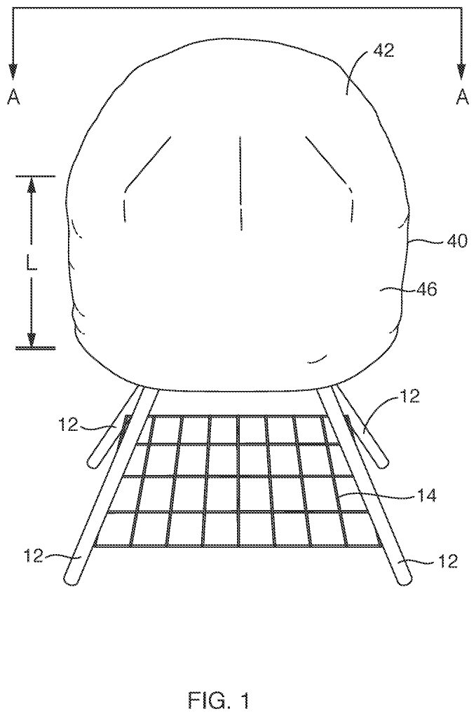

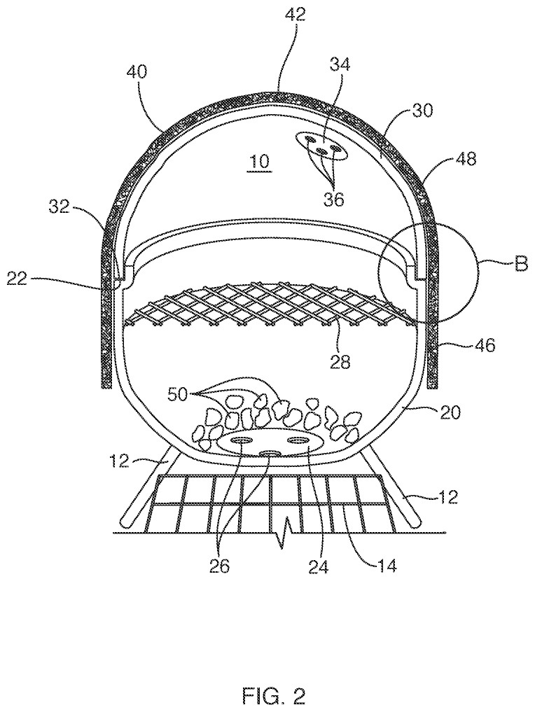

As shown in FIGS. 1 and 2, the various structure, composition, and features of the novel insulating cover for cookers is illustrated in an exemplary embodiment. Cooker 10 may comprise any conventional or specialized cooker. While a domed-shaped cooker such as a Weber cooker is depicted in FIGS. 1, 2 and 6, cooker 10 could have elongated, rectangular, box-like, cylinder-like, square or any other geometric configurations in the height, width, and depth of cooker 10.

Generally, cooker 10 may comprise a number of members. For example, cooker 10 may comprise a base member 20 and a top member 30 with supporting legs 12 and utility rack 14.

Cooker base 20 may comprise a circumscribing surface 22 to mate with top 30. Base 20 may further comprise air intake control 24 with inlet holes 26. The size, shape, position, and number of inlet holes 26 may vary and be a matter of design choice. Control 24 may be manipulated by the user to control the amount of fresh air entering cooker 10 to increase or retard, that is regulate, the combustion of fuel within cooker 10. In this way, the user may control the rate of combustion of fuel and the corresponding temperature within cooker 10. For purposes of illustration a food support surface 28 is disposed within cooker 10. Support surface 28 may be removable. Also for illustration, fuel 50 is placed in cooker 10 for the purposes discussed below.

Cooker top 30 may comprise a corresponding edge 32 received adjacent circumscribing surface 22 of base 20 to effect closure of cooker 10. Top 30 may include a smoke exhaust port 34 with vent holes 36. Like air intake control 25, smoke exhaust port 34 may be manipulated by the user to control the amount of smoke exiting cooker 10 to also increase or retard, that is regulate, the combustion of fuel within cooker 10. In this way, the user may control the rate of combustion of fuel and the corresponding temperature within cooker 10.

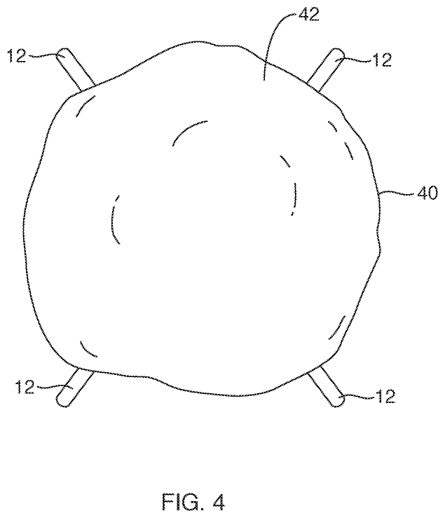

Cover 40 may comprise an upper or top portion 42 and lower or side portions 46. Upper portion 42 is configured to conform substantially to the shape of top 30 of cooker 10. Upper portion 42 may be constructed with no predefined openings or entry points as shown in top view in FIG. 4. The advantage of constructing upper portion 42 with no predefined openings or entry points will be discussed below in connection with the material of construction of cover 40. This provides the advantage of having a universal upper portion 42 allowing for efficiencies of production.

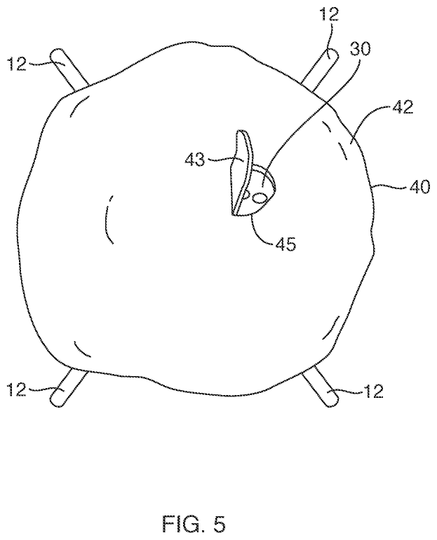

In another embodiment, see FIG. 5, upper portion 42 may be constructed with one or more predefined openings or entry points 45 when OEM specifications of cooker 10 identify to desired location of opening 45. Opening 45 may be created by altering a portion of the material of construction 48 to provide a flap 43 of upper portion 42 to reveal underlying cooker top 30 and/or exhaust port 34. A flap configuration may be preferred so that opening 45 may be selectively closed by the user as desired.

Side portions 46 may comprise a length L as illustrated in FIG. 1. Length L may vary or be altered by the user, as discussed below. As depicted in FIGS. 1 and 2, in one embodiment, length L of side portions 46 may terminate in its downward direction without extending to the ground or surface upon which cooker 10 rests. In another embodiment, length L of side portions 46 may extend to or substantially to the ground or surface upon which cooker 10 rests, or length L may be of any desired length to extend to any height between a portion of cooker 10 and the ground/surface upon which cooker 10 rests.

Insulating cover 40 is placed or draped about cooker 10 adjacent at least portions of top 30 and/or base 20. Cover 40 may entirely drape cooker 10 as shown in FIG. 1. Upper portion 42 of cover 40 is disposed about top 30 of cooker 10. Lower or side portions 46 of cover 40 extend or drape from upper portion 42.

Lower cover portion 46 extends downward from upper portion 42 so as to encompass a portion or all of base 20 of cooker 10. Lower portion 46 may also extend down near to the ground, or any length between upper portion 42 and the ground. Due to the nature of the construction material 48 of cover 40 discussed below, the user may alter the shape or length L of lower portion 45. In addition, the user may perforate, cut, or remove sections of lower portion 46 as desired to conform lower portion 46 to the structure of cooker 10 or to accommodate other cooking accessories, fuel related hardware or any other structure or impediment adjacent cooker 10.

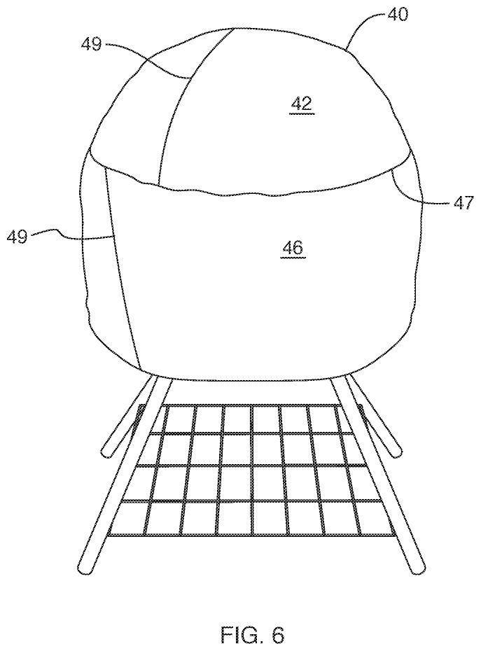

While it is contemplated that upper portion 42 and lower portion 46 are constructed as an integral unit, it is also contemplated that upper portion 42 and lower portion 46 could be separate but joined (see FIG. 6) or joinable members, or separate members placed adjacent each other.

Cover 40 may be constructed of an insulating material 48 that is formable, alterable, non-rigid, self-supporting, single-layered, flame retardant material and/or hygroscopic. For purposes of this patent the term “hygroscopic” means able to absorb and retain moisture while maintaining its insulating characteristics. The material of construction 48 of cover 40 has properties of thermal insulation. Thermal insulation increases heat retention and regulation within cooker 10 therefore reducing the amount of fuel consumed during the heating/cooking process.

Cover material 48 also includes material properties such that material 48 may be selectively altered by the user through piercing, cutting or shearing forces exerted by common hand tools such as a pair of scissors, a knife or razor-knife. For purposes of this patent the term “alterable” means have material properties such that the material can be readily customized by the user by piercing, cutting or shearing the cover material with common hand tools such as a pair of scissors, a knife or razor-knife.

Cover material 48 is formable. That is, material 48 can be drawn, urged, stretched, bent, molded or form from one orientation or shape into another orientation or shape without significant degradation of the strength, integrity, or other desired properties, discussed above and below, of material 48.

Cover material 48 is non-rigid such that cover 40 to be stored or transported in a flat or rolled condition thereby significantly reducing transportation, shipping, and storage space requirements.

Cover material 48 is sufficiently self-supporting such that it needs no under- or overlying support structure or framework to give cover 40 its desired shape in use.

Cover material 48 is preferably a single layer but may be multi-layered. While material 48 may be a composition of more than one substance, it is preferably sufficiently homogenous so as to maintain the other desired properties.

Cover material 48 should be flame retardant. Due to the potentially high temperature conditions of use of cooker 10, material 48 should be flame retardant. It is also desirable that material 48 be non-combustible under normal cooking temperatures.

Cover material 48 may absorb and/or retain moisture during the cooking/heating process such as materials which are hygroscopic in nature. This feature is optional but can be advantages depending the desired properties and/or environment of use. For example, if the user wishes to be able to clean material 48, moisture absorbency and/or retention may facilitate cleaning.

One or more of the forgoing properties of material 48 contribute to providing superior heat retention and regulation allowing the user to cooking meats, food, and other products under low or high temperature conditions.

An example of a suitable composition of material 48 is an amorphous polymer. Amorphous polymers have long chains of molecules in a random arrangement capable of complex folding. As a result, when heated, they can be reorganized and urged to assume new shapes without degrading the polymer. By applying proper stretching and/or bending forces to heated amorphous polymers, the heated polymers can take on myriad shapes. Suitable amorphous polymer materials occur naturally and can be manufactured synthetically.

One form of a natural amorphous polymer is wool. Depending on the nature of the intended use, wool can be processed using only its like-kind, naturally-occurring fibers. In the alternative, wool may be processed or blended with different kinds of wool fibers, with other natural fibers or with synthetic fibers, such as texturized or crimped synthetic fibers, into a single wool layer. Advantageously, wool gives off heat when it absorbs moisture making it a superior material 48 for cover 40. As a result, wool is an example of material 48 which is formable, alterable, non-rigid, self-supporting, single-layered, flame retardant and/or hygroscopic.

In the alternative, a natural or synthetic closed-cell composition, material or product, EPDM rubber-based elastomeric insulation or other man-made material having a sufficient number of the above described properties, or equivalents thereof, could be used as construction material 48 of cover 40. For examples, polymerized siloxanes or polysiloxanes such as silicone may be suitable because they can be highly thermal insulative, formable, alterable, non-rigid, self-supporting and can be configured in a single-layer application. Also, a silicone sponge material such as a closed cell, soft density foam that is manufactured with a continuous skin on both sides may be suitable.

Cover 40 may be manufactured or constructed in a number of ways. Because preferred cover material 48 is formable, that is, can be drawn, urged, stretched, bent, molded or form from one orientation or shape into another orientation or shape, in one embodiment cover 40 may be shaped as needed.

In an alternative embodiment (see FIG. 6), upper portion 42 may comprise a unit and lower or side portion 46 may comprise another unit. Upper portion 42 and/or side portion 46 may comprise a geometric shape attached at ends along a seam 49. In one embodiment, the upper portion 42 and lower portion 46 may be disposed about cooker 10 independent of each other. In another embodiment, upper portion 42 may be joined to side portion 46 along a seam 47. Seam 47 and/or 49 may be achieved by stitching, stapling, fusing, sewing, gluing, crimping or any similar or equivalent seaming or joining process or method such as a zipper, clips, hooks, clasps, and the like. Using either form of construction, a unitary or severable cover 40 may be constructed. For example, it may be desirable to have only a partial seam 47 about cooker 10 when access into cooker 10 is needed or frequent.

As mentioned previously, upper portion 42 may be constructed without any opening in or through upper portion 42; this is defined for purposes of this patent as a universal hood. A universal hood simplifies and reduces costs of production and manufacturing. Because material 48 is alterable, the user may readily customize the universal hood to select the exact size, location, and number of openings 45 in upper portion 42 to correspond to the underlying cooker 10 and/or to accommodate and facilitate the cooking technique(s) chosen by the user.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes that come within the meaning and range of equivalency of the claimed inventions are to be embraced within their scope.

What is claimed is:

1. A cooker cover apparatus comprising:
an upper portion configured as a universal hood;
a lower portion, wherein the upper portion and lower portion are disposed adjacent each other;
the upper portion and the lower portion being constructed of an amorphous polymer.

2. The apparatus of claim 1 wherein the amorphous polymer is flame retardant.

3. The apparatus of claim 1 wherein the amorphous polymer insulates for heat.

4. The apparatus of claim 1 wherein the amorphous polymer is formable.

5. The apparatus of claim 1 wherein the amorphous polymer is alterable.

6. The apparatus of claim 1 wherein the amorphous polymer is non-rigid.

7. The apparatus of claim 1 wherein the amorphous polymer is self-supporting.

8. The apparatus of claim 1 wherein the amorphous polymer is single-layered.

9. The apparatus of claim 1 wherein the amorphous polymer is hygroscopic.

10. The apparatus of claim 1 wherein the amorphous polymer is wool.

11. A cooker cover apparatus comprising:
an upper portion configured as a universal hood;
a lower portion, wherein the upper portion and lower portion are disposed adjacent each other;
the upper portion and the lower portion being constructed of a single-layered, synthetic material which is flame retardant and alterable.

12. The apparatus of claim 11 wherein the synthetic composition is a closed-cell product.

13. The apparatus of claim 12 further comprising a continuous skin on both sides of the closed-cell product.

14. The apparatus of claim 11 wherein the synthetic composition is an EPDM rubber-based elastomeric product.

15. The apparatus of claim 11 wherein the synthetic composition is a polymerized siloxane or polysiloxane.

16. The apparatus of claim 15 wherein the polymerized siloxane or polysiloxane is silicone.

17. The apparatus of claim 11 wherein the synthetic composition insulates for heat.

18. The apparatus of claim 11 wherein the synthetic composition is formable.

19. The apparatus of claim 11 wherein the synthetic composition is non-rigid.

20. The apparatus of claim 11 wherein the synthetic composition is self-supporting.
